(19) United States
(12) Patent Application Publication
(10) Pub. No.: US 2026/0279642 A1
(43) Pub. Date: Sep. 17, 2026

(54) MAGNETIC COMPONENT, ELECTRIC CIRCUIT, AND POWER CONVERSION CIRCUIT

(71) Applicant: KABUSHIKI KAISHA TOSHIBA, Kawasaki-shi (JP)

(72) Inventors: Keigo ARITA, Kawasaki Kanagawa (JP); Tatsunori SAKANO, Shinagawa Tokyo (JP)

(73) Assignee: KABUSHIKI KAISHA TOSHIBA, Kawasaki-shi (JP)

(21) Appl. No.: 19/447,154

(22) Filed: Jan. 13, 2026

(30) Foreign Application Priority Data
Mar. 13, 2025 (JP) 2025-040656

(51) Int. Cl. H01F 27/24; H01F 27/28; H02M 7/217

(52) U.S. Cl. CPC H01F 27/24; H01F 27/28; H02M 7/217

(57) ABSTRACT

According to one embodiment, a magnetic component includes a magnetic core portion, first to fourth conductive members. The magnetic core portion includes first to sixth cores. The first conductive member includes a first conductive portion and a second conductive portion. The third conductive member is wound around the fifth core in a fifth winding direction. The fourth conductive member is wound around the sixth core in a sixth winding direction. The sixth winding direction is opposite to the fifth winding direction.

### CROSS-REFERENCE TO RELATED APPLICATIONS

This application is based upon and claims the benefit of priority from Japanese Patent Application No. 2025-040656, filed on Mar. 13, 2025; the entire contents of which are incorporated herein by reference.

### FIELD

Embodiments described herein relate generally to a magnetic component, an electric circuit, and a power conversion circuit.

### BACKGROUND

For example, magnetic components including a conductive member wound around a magnetic core are used in power conversion circuits, etc. Performance improvements such as higher efficiency are desired for magnetic components.

### BRIEF DESCRIPTION OF THE DRAWINGS

FIG. 1 is a schematic view illustrating a magnetic component according to a first embodiment;

FIG. 2 is a schematic view illustrating the magnetic component according to the first embodiment;

FIG. 3 is an equivalent circuit diagram illustrating the magnetic component according to the first embodiment;

FIG. 4 is a schematic view illustrating the magnetic component according to the first embodiment;

FIG. 5 is a schematic diagram illustrating a magnetic component according to the first embodiment;

FIG. 6 is a schematic diagram illustrating a magnetic component according to the first embodiment;

FIG. 7 is a schematic diagram illustrating a magnetic component according to the first embodiment;

FIG. 8 is a schematic diagram illustrating a magnetic component according to the first embodiment;

FIG. 9 is an equivalent circuit diagram illustrating a power conversion circuit according to a third embodiment;

FIGS. 10A, 10B, 10C, and 10D are graphs illustrating the characteristics of the power conversion circuit according to the third embodiment;

FIG. 11 is an equivalent circuit diagram illustrating a power conversion circuit according to the third embodiment;

FIGS. 12A, 12B, and 12C are graphs illustrating the characteristics of the power conversion circuit according to the third embodiment; and

FIG. 13 is a schematic perspective view illustrating a magnetic component according to the embodiment.

### DETAILED DESCRIPTION

According to one embodiment, a magnetic component includes a magnetic core portion, a first conductive member, a second conductive member, a third conductive member, and a fourth conductive member. The magnetic core portion includes a first core, a second core, a third core, a fourth core, a fifth core, and a sixth core. The first conductive member includes a first conductive portion and a second conductive portion. The first conductive portion is wound around the first core in a first winding direction. The second conductive portion is wound around the second core in a second winding direction. The second winding direction is opposite to the first winding direction. The second conductive member includes a third conductive portion and a fourth conductive portion. The third conductive portion is wound around the third core in a third winding direction. The fourth conductive portion is wound around the fourth core in a fourth winding direction. The fourth winding direction is opposite to the third winding direction. The third conductive member is wound around the fifth core in a fifth winding direction. The fourth conductive member is wound around the sixth core in a sixth winding direction. The sixth winding direction is opposite to the fifth winding direction.

Various embodiments are described below with reference to the accompanying drawings.

The drawings are schematic and conceptual; and the relationships between the thickness and width of portions, the proportions of sizes among portions, etc., are not necessarily the same as the actual values. The dimensions and proportions may be illustrated differently among drawings, even for identical portions.

In the specification and drawings, components similar to those described previously or illustrated in an antecedent drawing are marked with like reference numerals, and a detailed description is omitted as appropriate.

### First Embodiment

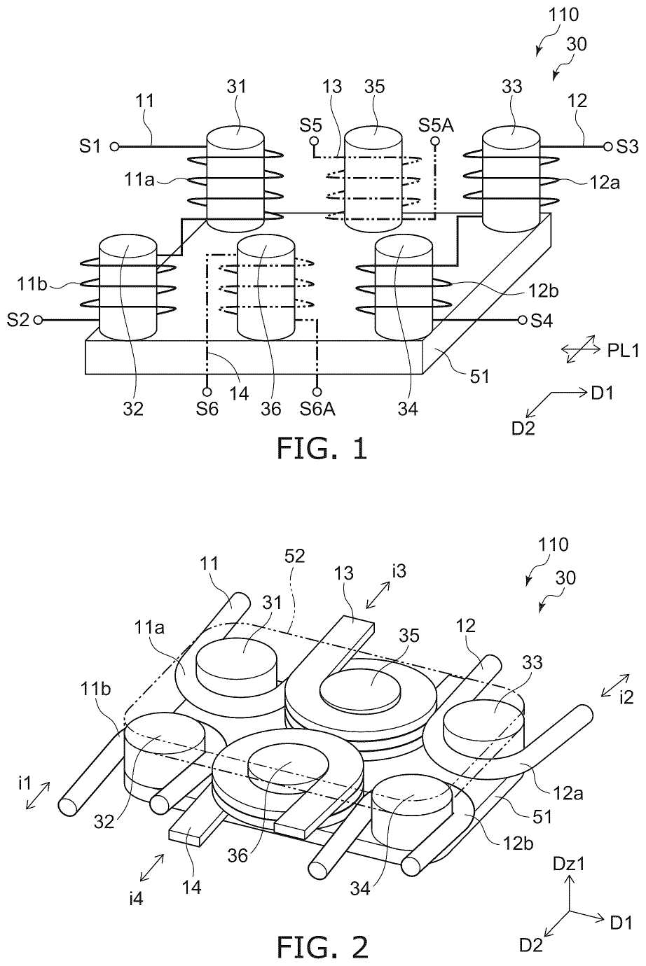

FIGS. 1, 2, and 4 are schematic views illustrating a magnetic component according to a first embodiment.

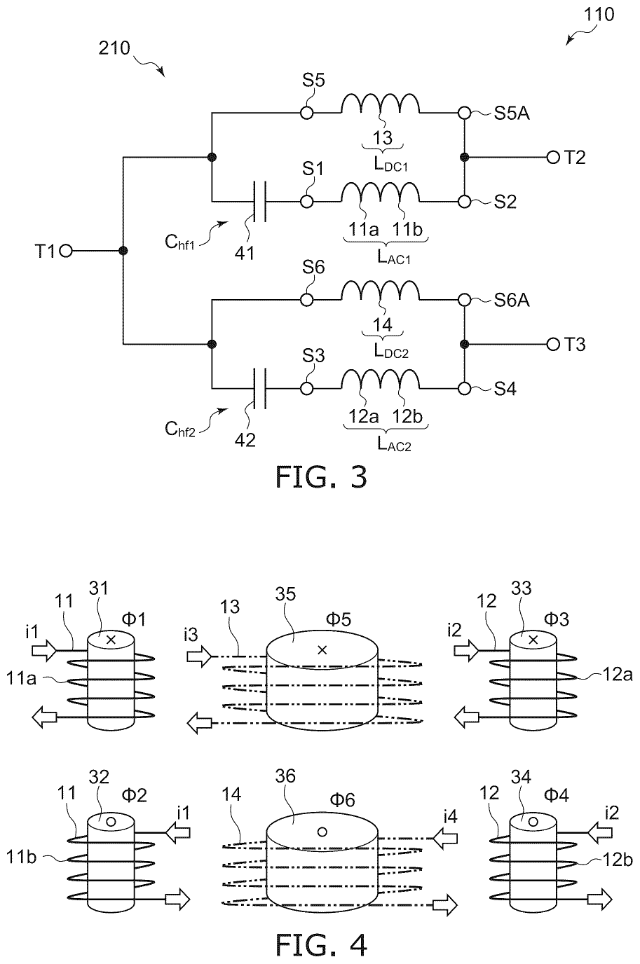

FIG. 3 is an equivalent circuit diagram illustrating a magnetic component and an electric circuit according to the first embodiment.

FIGS. 1, 2, and 4 are perspective views.

As shown in FIG. 1, a magnetic component 110 according to the embodiment includes a magnetic core portion 30, a first conductive member 11, a second conductive member 12, a third conductive member 13, and a fourth conductive member 14. The magnetic core portion 30 includes a first core 31, a second core 32, a third core 33, a fourth core 34, a fifth core 35, and a sixth core 36.

As shown in FIGS. 1 and 2, the first conductive member 11 includes a first conductive portion 11a and a second conductive portion 11b. The first conductive portion 11a is wound around the first core 31 in a first winding direction. The second conductive portion 11b is wound around the second core 32 in a second winding direction. The second winding direction is opposite to the first winding direction. The first conductive portion 11a is electrically connected in series with the second conductive portion 11b. The first conductive portion 11a is continuous with the second conductive portion 11b.

The second conductive member 12 includes a third conductive portion 12a and a fourth conductive portion 12b. The third conductive portion 12a is wound around the third core 33 in a third winding direction. The fourth conductive portion 12b is wound around the fourth core 34 in a fourth winding direction. The fourth winding direction is opposite to the third winding direction. The third conductive portion 12a is electrically connected in series with the fourth conductive portion 12b. The third conductive portion 12a is continuous with the fourth conductive portion 12b.

As shown in FIG. 4, for example, the first conductive member 11 is wound so that when a first current i1 is supplied, the first magnetic flux Φ1 passing through the first core 31 includes a component whose direction is opposite to the direction of the second magnetic flux Φ2 passing through the second core 32. For example, the second conductive member 12 is wound so that when the second current i2 is supplied, the third magnetic flux Φ3 passing through the third core 33 includes a component whose direction is opposite to the direction of the fourth magnetic flux Φ4 passing through the fourth core 34.

As shown in FIG. 4, the third conductive member 13 is wound around the fifth core 35 in a fifth winding direction. The fourth conductive member 14 is wound around the sixth core 36 in a sixth winding direction. The sixth winding direction is opposite to the fifth winding direction.

For example, the third conductive member 13 is wound so that when the third current i3 is supplied, the fifth magnetic flux Φ5 passing through the fifth core 35 includes a component whose direction is opposite to the sixth magnetic flux Φ6 passing through the sixth core 36 when the fourth current i4 is supplied to the fourth conductive member 14.

In the embodiment, the first conductive member 11 is wound around the first core 31 and the second core 32, and the wound directions are opposite to each other on the first core 31 and the second core 32. The second conductive member 12 is wound around the third core 33 and the fourth core 34, and the wound directions are opposite to each other on the third core 33 and the fourth core 34. For the third conductive member 13 wound around the fifth core 35 and the fourth conductive member 14 wound around the sixth core 36, the wound direction is opposite to each other. Due to the winding in opposite directions, the volume and loss of the magnetic cores is reduced. According to the embodiment, a magnetic component with improved performance can be provided. When a current flows through a conductor, the direction of the current, as viewed with the crossing direction Dz1 from the first base portion 51 to the second base portion 52 as the axis of rotation, can be considered the winding direction and the wound direction. The direction of rotation from one end of a line-shaped conductive member to the other end, with the crossing direction Dz1 from the first base portion 51 to the second base portion 52 as the axis, can also be considered the winding direction and the wound direction.

In the embodiment, the magnetic component includes a number of cores corresponding to the type of current and windings wound around each core. In a case where any one of the electrical characteristics of the current (current value, frequency, phase, waveform) differs, it is considered to be a different type of current. For one type of current, two cores are selected and windings for passing the corresponding current are wound around them. The positions of the two cores and the winding directions of the windings are selected in a combination that cancels out the magnetic flux generated in the other core. The current flowing through the magnetic component can be separated by type. A power conversion circuit is constructed using magnetic components and capacitors. A plurality of inductors included in a power converter can be integrated. For example, the performance of the inductors can be improved, resulting in a compact, highly efficient power converter.

In the embodiment, the plurality of inductors can be integrated in the magnetic component 110. The volume of the magnetic component 110 can be reduced. For example, the height of the magnetic component 110 can be reduced. The magnetic component 110 can be applied to multi-phase circuits. For example, the magnetic component 110 can be applied to multi-phase converters (such as interleaved converters). The volume of the multi-phase converter can be reduced.

For example, the first conductive member 11 and the second conductive member 12 function as inductors for passing AC current components (AC inductors). For example, the third conductive member 13 and the fourth conductive member 14 function as inductors for passing DC current components (DC inductors). In this case, the first conductive member 11 and the second conductive member 12 may include, for example, a Litz wire or a twisted wire. For example, the third conductive member 13 and the fourth conductive member 14 may include an edgewise coil. The third conductive member 13 and the fourth conductive member 14 have a width in a direction crossing the crossing direction Dz1 that is greater than the thickness in the direction along the crossing direction Dz1. Configurations suitable for both AC inductors and DC inductors are applied. Higher efficiency is easily obtained.

As shown in FIG. 2, the magnetic core portion 30 may further include a first base portion 51. The first base portion 51 is connected to the first core 31, the second core 32, the third core 33, the fourth core 34, the fifth core 35, and the sixth core 36. The first base portion 51 has, for example, a flat plate shape extending in a first direction D1 and a second direction D2. The first core 31, the second core 32, the third core 33, the fourth core 34, the fifth core 35, and the sixth core 36 extend, for example, from the first base portion 51 along the crossing direction Dz1. The crossing direction Dz1 crosses a plane including the first direction D1 and the second direction D2. The crossing direction Dz1 is the height direction of the magnetic component 110.

The magnetic core portion 30 may further include a second base portion 52. The first core 31, the second core 32, the third core 33, the fourth core 34, the fifth core 35, and the sixth core 36 are provided between the first base portion 51 and the second base portion 52. The second base portion 52 may be connected to the first core 31, the second core 32, the third core 33, the fourth core 34, the fifth core 35, and the sixth core 36. In FIG. 2, the second base portion 52 is drawn in perspective for clarity. The second base portion 52 has, for example, a flat plate shape extending in the first direction D1 and the second direction D2. In a plan view along the crossing direction Dz1, the first core 31, the second core 32, the third core 33, the fourth core 34, the fifth core 35, and the sixth core 36 are located inside the outer edges of the first base portion 51 and the second base portion 52. The relative positions of the first core 31, second core 32, third core 33, fourth core 34, fifth core 35, and sixth core 36 are arbitrary.

The first core 31, second core 32, third core 33, fourth core 34, fifth core 35, and sixth core 36 may include, for example, ferrite. The first base portion 51 and second base portion 52 may include, for example, ferrite. The first conductive member 11, second conductive member 12, third conductive member 13, and fourth conductive member 14 may include, for example, copper, aluminum, silver, or gold. The materials of these components can be varied in various ways.

As shown in FIG. 3, the magnetic component 110 may further include a first connection point S1, a second connection point S2, a third connection point S3, a fourth connection point S4, a fifth connection point S5, a fifth other connection point S5A, a sixth connection point S6, and a sixth other connection point S6A. These connection points may be, for example, terminals.

The first connection point S1 is electrically connected to a part of the first conductive portion 11a. Another part of the first conductive portion 11a is electrically connected to a part of the second conductive portion 11b. The second connection point S2 is electrically connected to another part of the second conductive portion 11b. The fifth connection point S5 is electrically connected to another part of the third conductive member 13. The fifth other connection point S5A is electrically connected to another part of the third conductive member 13. The third connection point S3 is electrically connected to a part of the third conductive portion 12a. Another part of the third conductive portion 12a is electrically connected to another part of the fourth conductive portion 12b. The fourth connection point S4 is electrically connected to another part of the fourth conductive portion 12b. The sixth connection point S6 is electrically connected to a part of the fourth conductive member 14. The sixth other connection point S6A is electrically connected to another part of the fourth conductive member 14. The above “part” may be, for example, one end. The above “another par” may be, for example, another end.

For example, the second connection point S2 is electrically connected to the fifth other connection point S5A. The first conductive member 11 and the third conductive member 13 are electrically connected in parallel. For example, the fourth connection point S4 is electrically connected to the sixth other connection point S6A. The second conductive member 12 and the fourth conductive member 14 are electrically connected in parallel.

The first conductive portion 11a and the second conductive portion 11b function, for example, as AC inductors. As already explained, the third conductive member 13 functions, for example, as a DC inductor. The first conductive portion 11a and the second conductive portion 11b have, for example, a first AC inductance L_{AC1}. The third conductive member 13 has, for example, a first DC inductance L_{DC1}. The third conductive portion 12a and the fourth conductive portion 12b function, for example, as AC inductors. As already described, the fourth conductive member 14 functions as, for example, a DC inductor. The third conductive portion 12a and the fourth conductive portion 12b have, for example, a second AC inductance L_{AC2}. The fourth conductive member 14 has, for example, a second DC inductance L_{DC2}.

The magnetic component 110 according to the embodiment can be applied to an electric circuit 210 (see FIG. 3). The electric circuit 210 includes the magnetic component 110 according to the embodiment, a first capacitor 41, and a second capacitor 42. The first capacitor 41 is configured to be coupled to the first conductive member 11, for example. The first capacitor 41 has a first capacitance C_{hf1}. The second capacitor 42 is configured to be coupled to the second conductive member 12, for example. The second capacitor 42 has a second capacitance C_{hf2}.

As shown in FIG. 3, a part of the first capacitor 41 is electrically connected to a part of the third conductive member 13. Another part of the first capacitor 41 is electrically connected to a part of the first conductive portion 11a. A part of the second capacitor 42 is electrically connected to a part of the fourth conductive member 14. Another part of the second capacitor 42 is electrically connected to a part of the third conductive portion 12a.

As shown in FIG. 3, the electric circuit 210 may include a first terminal T1, a second terminal T2, and a third terminal T3. The first terminal T1 is electrically connected to a part of the third conductive member 13 (and a part of the first capacitor 41) and a part of the fourth conductive member 14 (and a part of the second capacitor 42). The second terminal T2 is electrically connected to the second connection point S2 and the fifth other connection point S5A. The third terminal T3 is electrically connected to the fourth connection point S4 and the sixth other connection point S6A. For example, the first terminal T1 may function as an input terminal. For example, the second terminal T2 and the third terminal T3 may function as output terminals.

As described below, in the embodiments, various modifications are possible to the wound state of the conductive portions. The following describes examples of the first conductive portion 11a, the second conductive portion 11b, the third conductive portion 12a, the fourth conductive portion 12b, the third conductive member 13, and the fourth conductive member 14.

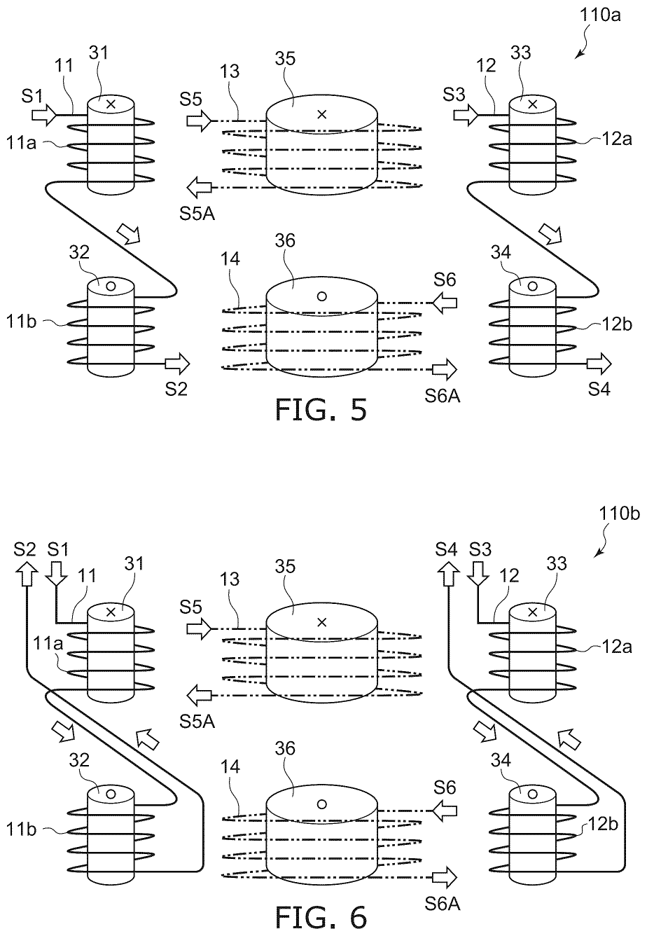

FIGS. 5 to 8 are schematic diagrams illustrating magnetic components according to the first embodiment.

As shown in FIG. 5, in a magnetic component 110a according to the embodiment, the first conductive portion 11a is wound continuously in a first number of turns around first core 31. The second conductive portion 11b is wound continuously in a second number of turns around second core 32. The third conductive portion 12a is wound continuously in a third number of turns around third core 33. The fourth conductive portion 12b is wound continuously in a fourth number of turns around fourth core 34.

As shown in FIGS. 5 to 8, in the magnetic component 110a, a magnetic component 110b, a magnetic component 110c, and a magnetic component 110d according to the embodiment, the third conductive member 13 is wound in a fifth number of turns around fifth core 35. The fourth conductive member 14 is wound in a sixth number of turns around sixth core 36. The fifth number of turns and the sixth number of turns are two or more.

In this example, for example, the first number of turns, the second number of turns, the third number of turns, and the fourth number of turns are two or more. In the embodiment, for example, the first number of turns is the same as the second number of turns. For example, the third number of turn is the same as the fourth number of turns. For example, magnetic flux is more likely to be canceled out. The first to fourth numbers of turns may be illustrated as increasing or decreasing by half a turn.

As shown in FIG. 5, in the magnetic component 110a, the first connection point S1 is electrically connected to a part of the first conductive portion 11a near the first core 31. The second connection point S2 is electrically connected to another part of the second conductive portion 11b near the second core 32. The third connection point S3 is electrically connected to a part of the third conductive portion 12a near the third core 33. The fourth connection point S4 is electrically connected to another part of the fourth conductive portion 12b near the fourth core 34.

As shown in FIG. 6, in a magnetic component 110b according to the embodiment, the first connection point S1 is electrically connected to a part of the first conductive portion 11a near the first core 31. The second connection point S2 is electrically connected to another part of the second conductive portion 11b near the first core 31. The third connection point S3 is electrically connected to a part of the third conductive portion 12a near the third core 33. The fourth connection point S4 is electrically connected to another part of the fourth conductive portion 12b near the third core 33.

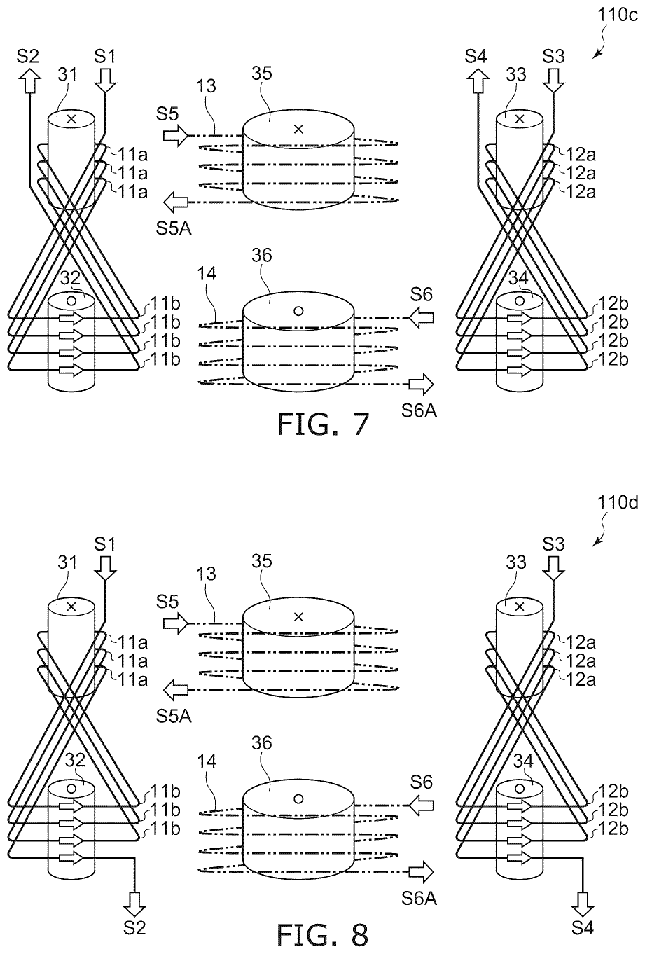

As shown in FIG. 7, a magnetic component 110c according to the embodiment includes a plurality of first conductive portions 11a and a plurality of second conductive portions 11b. One of the plurality of first conductive portions 11a is located between one of the plurality of second conductive portions 11b and another on of the plurality of second conductive portions 11b. One of the plurality of second conductive portions 11b is located between one of the plurality of first conductive portions 11a and another one of the plurality of first conductive portions 11a.

The magnetic component 110c may include a plurality of third conductive portions 12a and a plurality of fourth conductive portions 12b. One of the plurality of third conductive portions 12a is located between one of the plurality of fourth conductive portions 12b and another one of the plurality of fourth conductive portions 12b. One of the plurality of fourth conductive portions 12b is located between one of the plurality of third conductive portions 12a and another one of the plurality of third conductive portions 12a.

In the magnetic component 110c, the first connection point S1 is electrically connected to a part of the first conductive portion 11a near the first core 31. The second connection point S2 is electrically connected to another part of the second conductive portion 11b near the first core 31. The third connection point S3 is electrically connected to a part of the third conductive portion 12a near the third core 33. The fourth connection point S4 is electrically connected to another part of the fourth conductive portion 12b near the third core 33.

As shown in FIG. 8, a magnetic component 110d according to the embodiment also has a plurality of first conductive portions 11a, a plurality of second conductive portions 11b, a plurality of third conductive portions 12a, and a plurality of fourth conductive portions 12b. In magnetic component 110d, the first connection point S1 is electrically connected to a part of first conductive portion 11a near the first core 31. The second connection point S2 is electrically connected to another part of second conductive portion 11b near the second core 32. Third connection point S3 is electrically connected to a part of third conductive portion 12a near the third core 33. The fourth connection point S4 is electrically connected to another part of fourth conductive portion 12b near the fourth core 34.

In the magnetic component 110a, the magnetic component 110b, the magnetic component 110c, and the magnetic component 110d, the fifth connection point S5 is electrically connected to a part of third conductive member 13 near the fifth core 35. The fifth other connection point S5A is electrically connected to another part of third conductive member 13 near the fifth core 35. The sixth connection point S6 is electrically connected to a part of the fourth conductive member 14 near the sixth core 36. The sixth other connection point S6A is electrically connected to another part of the fourth conductive member 14 near the sixth core 36.

In magnetic component 110, the magnetic component 110a, and the magnetic component 110b, the fifth number of turns may be greater than the first number of turns. This allows, for example, the first DC inductance L_{DC1} (direct current) to be sufficiently greater than the first AC inductance L_{AC1} (alternating current). As a result, flow of AC current through the third conductive member 13 is suppressed. Low loss is more easily obtained. In one example, the fifth number may be three or more times the first number of turns. Low loss is effectively obtained.

For example, the first DC inductance L_{DC1} of the third conductive member 13 may be nine or more times the first AC inductance L_{AC1} of the first conductive member 11.

In the magnetic component 110, the magnetic component 110a, and the magnetic component 110b, the sixth number of turns may be greater than the third number of turns. This allows, for example, the second DC inductance L_{DC2} (direct current) to be sufficiently greater than the second AC inductance L_{AC2} (alternating current). As a result, flow of AC current through the fourth conductive member 14 is suppressed. Low loss is easily obtained. In one example, the sixth number of turns may be three or more times the third number of turns. Low loss is effectively obtained.

For example, the second DC inductance L_{DC2} of the fourth conductive member 14 may be nine or more times the second AC inductance L_{AC2} of the second conductive member 12.

For example, the magnetic component 110 according to the embodiment may further include a coil having a third AC inductance L_{AC3}. Thy types of corresponding AC current can be increased.

For example, the magnetic core portion 30 may further include other cores (such as a seventh core and an eighth core). The magnetic component according to the embodiment (such as the magnetic component 110) may further include other conductive members (such as a fifth conductive member). The other cores (such as the seventh core and the eighth core) may have the same configuration as the first core 31 and the second core 32. The other conductive members (such as the fifth conductive member) may have the same configuration as the first conductive member 11.

### Second Embodiment

The second embodiment relates to the electric circuit 210 (see FIG. 3). As already described, the electric circuit 210 includes the magnetic components (110, 110a-110d, etc.) according to the embodiment, the first capacitor 41, and the second capacitor 42. The first capacitor 41 is configured to be coupled to the first conductive member 11, for example. The first capacitor 41 has the first capacitance C_{hf1}. The second capacitor 42 is configured to be coupled to the second conductive member 12, for example. The second capacitor 42 has the second capacitance C_{hf2}.

A first switching frequency is defined as f_{sw1}. The first AC inductance of the first conductive member 11 is defined as L_{AC1}. In this case, the first capacitance C_{hf1} of the first capacitor 41 is preferably smaller than 1/{4π²·(f_{sw1})²·L_{AC1}}. This allows the first conductive member 11 to function sufficiently as an inductor at the switching frequency (target frequency). For example, the first capacitance C_{hf1} is equal to or less than ⅕ of 1/{4π²·(f_{sw1})²·L_{AC1}}. The first switching frequency f_{sw1} corresponds to the operating frequency of the power conversion circuit including the electric circuit 210.

The second switching frequency is defined as f_{sw2}. The second AC inductance of the second conductive member 12 is defined as L_{AC2}. In this case, the second capacitance C_{hf2} of the second capacitor 42 is preferably smaller than 1/{4π²·(f_{sw2})²·L_{AC2}}. This allows the second conductive member 12 to function sufficiently as an inductor at the switching frequency (target frequency). For example, the second capacitance C_{hf2} is equal to or smaller than 1/{4π²·(f_{sw2})²·L_{AC2}}. The second switching frequency f_{sw2} corresponds to the operating frequency of the power conversion circuit including the electric circuit 210.

### Third Embodiment

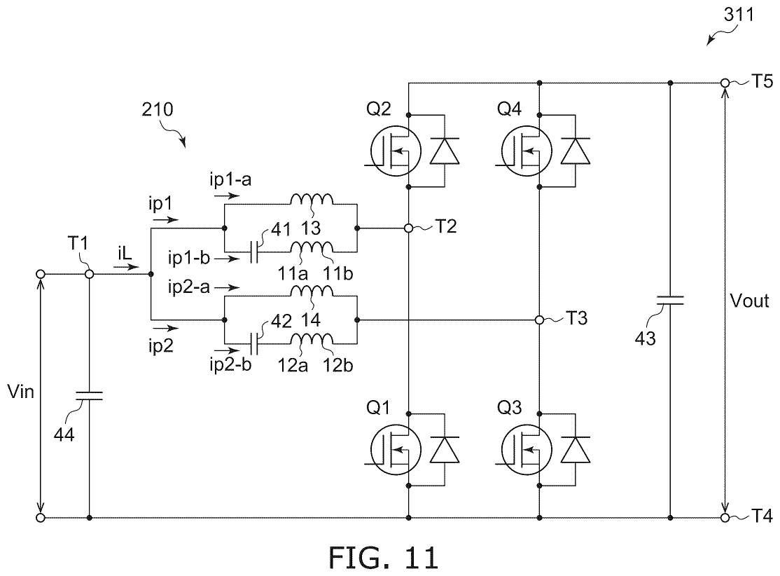

FIG. 11 is an equivalent circuit diagram illustrating a power conversion circuit according to a third embodiment.

As shown in FIG. 11, a power conversion circuit 311 according to the embodiment includes the electric circuit 210 according to the second embodiment, a first switch element Q1, a second switch element Q2, a third switch element Q3, a fourth switch element Q4, a fourth terminal T4, and a fifth terminal T5. The second switch element Q2 is electrically connected in series with the first switch element Q1. The fourth switch element Q4 is electrically connected in series with the third switch element Q3. The first switch element Q1 to the fourth switch element Q4 may be, for example, MOSFETs.

The electric circuit 210 includes the first terminal T1, the second terminal T2, and the third terminal T3. The power conversion circuit 311 may further include the third capacitor 43. A part of the third capacitor 43 is electrically connected to the fourth terminal T4, a part of the first switch element Q1, and a part of the third switch element Q3. The second terminal T2 is electrically connected to another part of the first switch element Q1 and a part of the second switch element Q2. The third terminal T3 is electrically connected to the other part of the third switch element Q3 and a part of the fourth switch element Q4. The other part of the third capacitor 43 is electrically connected to the fifth terminal T5, the other part of the second switch element Q2, and the other part of the fourth switch element Q4.

The power conversion circuit 311 may further include a fourth capacitor 44. A part of the fourth capacitor 44 is electrically connected to a part of the first switch element Q1, a part of the third switch element Q3, a part of the third capacitor 43, and the fourth terminal T4. Another part of the fourth capacitor 44 is electrically connected to the first terminal T1.

For example, a voltage between the fourth terminal T4 and the first terminal T1 is defined as a first voltage Vin. A voltage between the fourth terminal T4 and the fifth terminal T5 is defined as a second voltage Vout. In the power conversion circuit 311, for example, the first voltage Vin is converted to the second voltage Vout. In the power conversion circuit 311, for example, voltage conversion is performed.

For example, an input current iL flows through the first terminal T1. The input current iL is separated into a first partial current ip1 and a second partial current ip2. The first partial current ip1 is given by the sum of the current component ip1-a flowing through the third conductive member 13 and the current component ip1-b flowing through the first conductive member 11. The second partial current ip2 is given by the sum of the current component ip2-a flowing through the fourth conductive member 14 and the current component ip2-b flowing through the second conductive member 12.

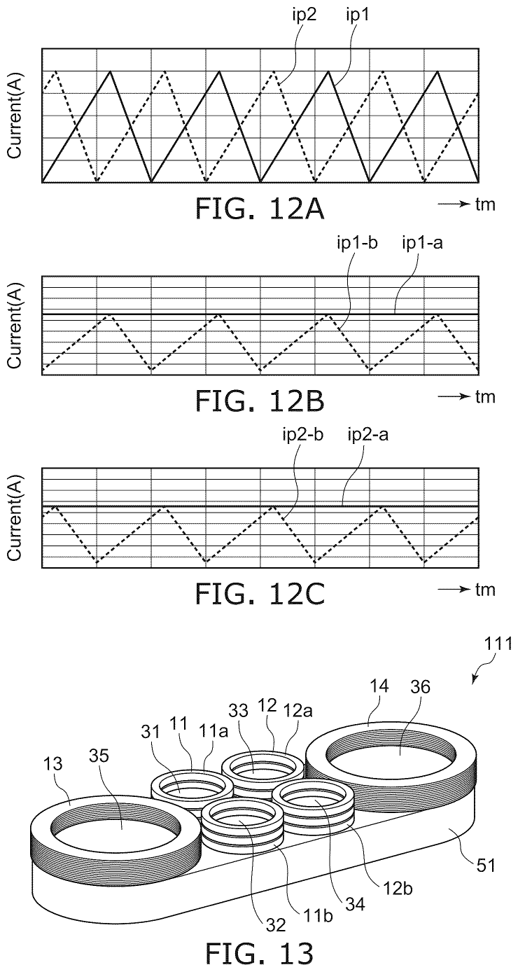

FIGS. 12A, 12B, and 12C are graphs illustrating the characteristics of the power conversion circuit according to the third embodiment.

The horizontal axis of these graphs represents time tm. The vertical axis represents current. FIG. 12A illustrates the first partial current ip1 and the second partial current ip2 of the power conversion circuit 311.

As shown in FIG. 12, the first partial current ip1 is separated into a DC current component ip1-a and a triangular wave current component ip1-b. Furthermore, the second partial current ip2 is separated into a DC current component ip2-a and a triangular wave current component ip2-b that is in phase with the current component ip1-b. The power conversion circuit 311 corresponds to, for example, an interleaved chopper circuit. The current components ip1-a and ip2-a may be DC current components with the same electrical characteristics.

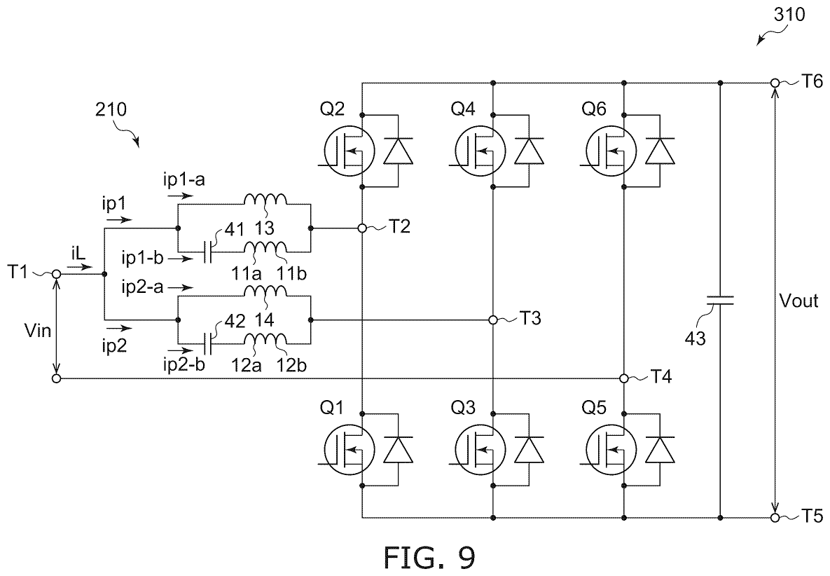

FIG. 9 is an equivalent circuit diagram illustrating a power conversion circuit according to the third embodiment.

As shown in FIG. 9, a power conversion circuit 310 according to the embodiment includes the electric circuit 210 according to the second embodiment, the first switch element Q1, the second switch element Q2, the third switch element Q3, the fourth switch element Q4, a fifth switch element Q5, a sixth switch element Q6, a fourth terminal T4, a fifth terminal T5, and a sixth terminal T6. The second switch element Q2 is electrically connected in series with the first switch element Q1. The fourth switch element Q4 is electrically connected in series with the third switch element Q3. The sixth switch element Q6 is electrically connected in series with the fifth switch element Q5. The first switch element Q1 to the sixth switch element Q6 may be, for example, MOSFETs.

The electric circuit 210 includes the first terminal T1, the second terminal T2, and the third terminal T3. The power conversion circuit 310 may further include the third capacitor 43. A part of the third capacitor 43 is electrically connected to the fifth terminal T5, a part of the first switch element Q1, a part of the third switch element Q3, and a part of the fifth switch element Q5. Another part of the third capacitor 43 is electrically connected to the sixth terminal T6, a part of the second switch element Q2, a part of the fourth switch element Q4, and a part of the sixth switch element Q6. The second terminal T2 is electrically connected to a part of the first switch element Q1 and a part of the second switch element Q2. The third terminal T3 is electrically connected to a part of the third switch element Q3 and a part of the fourth switch element Q4. The fourth terminal T4 is electrically connected to a part of the fifth switch element Q5 and a part of the sixth switch element Q6.

For example, The voltage between the fourth terminal T4 and the first terminal T1 is the first voltage Vin. The voltage between the fifth terminal T5 and the sixth terminal T6 is the second voltage Vout. In the power conversion circuit 310, for example, the first voltage Vin is converted into the second voltage Vout. In the power conversion circuit 310, for example, voltage conversion is performed.

For example, an input current iL flows through the first terminal T1. The input current iL is separated into a first partial current ip1 and a second partial current ip2. The first partial current ip1 is given by the sum of the current component ip1-a flowing through the third conductive member 13 and the current component ip1-b flowing through the first conductive member 11. The second partial current ip2 is given by the sum of the current component ip2-a flowing through the fourth conductive member 14 and the current component ip2-b flowing through the second conductive member 12.

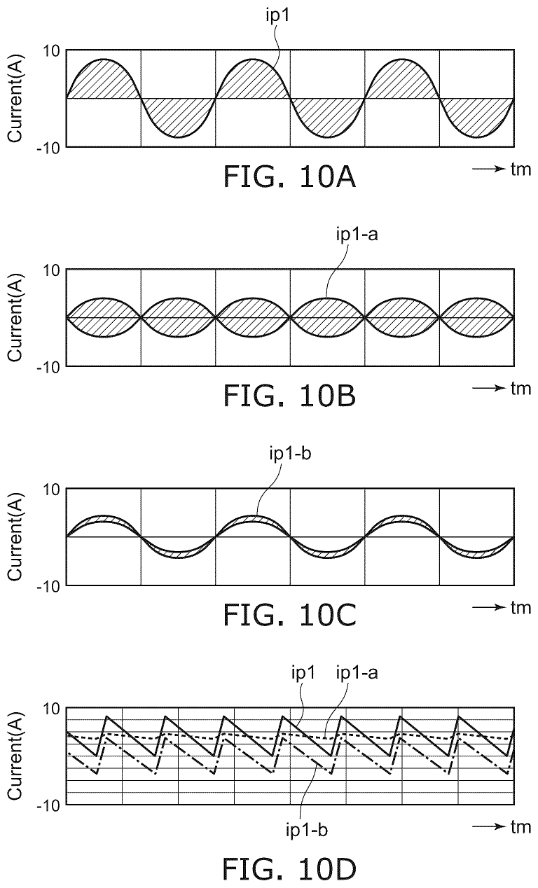

FIGS. 10A, 10B, 10C, and 10D are graphs illustrating the characteristics of the power conversion circuit 310 according to the third embodiment.

The horizontal axis in these figures represents time tm. The vertical axis represents current. FIG. 10D shows an enlarged view of the time axes in FIGS. 10A through 10C. FIG. 10A illustrates the first partial current ip1. FIG. 10B illustrates the current component ip1-a. FIG. 10C illustrates the current component ip1-b.

As shown in FIG. 10D, the first partial current ip1 is separated into a low-frequency current component ip1-a and a high-frequency current component ip1-b. The second partial current ip2 has same configuration. The power conversion circuit 310 corresponds to, for example, an interleaved totem-pole converter circuit.

FIG. 13 is a schematic perspective view illustrating a magnetic component according to the embodiment.

In FIG. 13, the first core 31, the second core 32, the third core 33, the fourth core 34, the fifth core 35, and the sixth core 36 are illustrated while the second base portion 52 is omitted.

As shown in FIG. 13, in a magnetic component 111 according to the embodiment, the first core 31, the second core 32, the third core 33, and the fourth core 34 are located between the fifth core 35 and the sixth core 36. For example, the volume of the fifth core 35 is larger than the volume of each of the first core 31, the second core 32, the third core 33, and the fourth core 34. For example, the volume of the sixth core 36 is larger than the volume of each of the first core 31, the second core 32, the third core 33, and the fourth core 34. A part of the third conductive member 13 is located between a part of the first conductive portion 11a and a part of the second conductive portion 11b. A part of the fourth conductive member 14 is located between a part of the third conductive portion 12a and a part of the fourth conductive portion 12b. By applying the above-described configuration to the arrangement of plurality of cores, it is possible to reduce the size of the magnetic component 111, for example.

According to the embodiments, it is possible to provide a magnetic component, an electric circuit, and a power conversion circuit that can improve performance.

Hereinabove, exemplary embodiments of the invention are described with reference to specific examples. However, the embodiments of the invention are not limited to these specific examples. For example, one skilled in the art may similarly practice the invention by appropriately selecting specific configurations of components included in the magnetic components, the electric circuits, and the power conversion circuits, such as core portions, cores, conductive members, capacitors, switching elements, etc., from known art. Such practice is included in the scope of the invention to the extent that similar effects thereto are obtained.

Further, any two or more components of the specific examples may be combined within the extent of technical feasibility and are included in the scope of the invention to the extent that the purport of the invention is included.

Moreover, all magnetic components, all electric circuits, and all power conversion circuits practicable by an appropriate design modification by one skilled in the art based on the magnetic components, the electric circuits, and the power conversion circuits, described above as embodiments of the invention also are within the scope of the invention to the extent that the purport of the invention is included.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A magnetic component, comprising:
a magnetic core portion including a first core, a second core, a third core, a fourth core, a fifth core, and a sixth core;
a first conductive member including a first conductive portion and a second conductive portion, the first conductive portion being wound around the first core in a first winding direction, the second conductive portion being wound around the second core in a second winding direction, the second winding direction being opposite to the first winding direction;
a second conductive member including a third conductive portion and a fourth conductive portion, the third conductive portion being wound around the third core in a third winding direction, the fourth conductive portion being wound around the fourth core in a fourth winding direction, the fourth winding direction being opposite to the third winding direction;
a third conductive member being wound around the fifth core in a fifth winding direction;
a fourth conductive member being wound around the sixth core in a sixth winding direction, the sixth winding direction being opposite to the fifth winding direction.

2. The magnetic component according to claim 1, wherein
the first conductive member and the second conductive member are configured to function as AC inductors, and
the third conductive member and the fourth conductive member are configured to function as DC inductors.

3. The magnetic component according to claim 1, wherein:
the first conductive portion is wound continuously in a first number of turns around the first core,
the second conductive portion is wound continuously a in a second number of turns around the second core,
the second number of turns is the same as the first number of turns,
the third conductive portion is wound continuously in a third number of turns around the third core,
the fourth conductive portion is wound continuously in a fourth number of turns around the fourth core,
the fourth number of turns is the same as the third number of turns,
the third conductive member is wound continuously in a fifth number of turns around the fifth core,
the fourth conductive member is wound continuously in a sixth number of turns around the sixth core, and
the sixth number of turns is the same as the fifth number of turns.

4. The magnetic component according to claim 3, wherein
the fifth number of turns is greater than the first number of turns, and
the sixth number of turns is greater than the third number of turns.

5. The magnetic component according to claim 3, further comprising:
a fifth conductive member,
the magnetic core portion further including a seventh core and an eighth core,
the fifth conductive member including a seventh conductive portion and an eighth conductive portion,
the seventh conductive portion being wound in a seventh number of turns around the seventh core in a seventh winding direction,
the eighth conductive portion being wound in an eighth number of turns around the eighth core in an eighth winding direction, and
the eighth winding direction being opposite to the seventh winding direction.

6. The magnetic component according to claim 3, wherein
a plurality of the first conductive portions are provided,
a plurality of the second conductive portions are provided,
one of the plurality of first conductive portions is located between one of the plurality of second conductive portions and another one of the plurality of second conductive portions, and
the one of the plurality of second conductive portions is located between the one of the plurality of first conductive portions and another one of the plurality of first conductive portions.

7. The magnetic component according to claim 3, wherein
a plurality of the third conductive portions are provided,
a plurality of the fourth conductive portions are provided,
one of the third conductive portions is located between one of the fourth conductive portions and another one of the fourth conductive portions, and
the one of the fourth conductive portions is located between the one of the third conductive portions and another one of the third conductive portions.

8. An electric circuit, comprising
the magnetic component according to claim 3;
a first capacitor; and
a second capacitor,
the first capacitor being configured to be coupled to the first conductive member, and
the second capacitor is configured to be coupled to the second conductive member.

9. The electric circuit according to claim 8, wherein
a part of the first capacitor is connected to a part of the third conductive member, a part of the fourth conductive member, and a part of the second capacitor,
another part of the first capacitor is connected to a part of the first conductive portion,
another part of the first conductive portion is connected to a part of the second conductive portion,
another part of the second conductive portion is connected to another part of the third conductive member,
another part of the second capacitor is connected to a part of the third conductive portion,
another part of the third conductive portion is connected to a part of the fourth conductive portion, and
another part of the fourth conductive portion is connected to another part of the fourth conductive member.

10. The electric circuit according to claim 8, wherein,
a first switching frequency is f_{sw1},
an inductance of the first conductive member is L_{AC1},
a capacitance of the first capacitor C_{hf1} is less than or equal to 1/{4π²·(f_{sw1})²·L_{AC1}},
a second switching frequency is f_{sw2},
an inductance of the second conductive member is L_{AC2}, and
a capacitance of the second capacitor C_{hf2} is less than or equal to 1/{4π²·(f_{sw2})²·L_{AC2}}.

11. A power conversion circuit, comprising:
the electric circuit according to claim 9;
a first switch element;
a second switch element;
a third switch element; and
a fourth switch element,
the electric circuit includes a first terminal, a second terminal, and a third terminal,
the first terminal is electrically connected to the part of the third conductive member,
the second terminal is electrically connected to the other part of the third conductive member,
the third terminal is electrically connected to the other part of the fourth conductive member,
a part of the first switch element is electrically connected to a part of the third switch element,
the second terminal is electrically connected to the other part of the first switch element and a part of the second switch element,
the third terminal is electrically connected to the other part of the third switch element and a part of the fourth switch element, and
the other part of the second switch element is connected to the other part of the fourth switch element.

12. A power conversion circuit, comprising:
the electric circuit according to claim 9;
a first switch element;
a second switch element;
a third switch element;
a fourth switch element;
a fifth switch element; and
a sixth switch element,
the electric circuit including a first terminal, a second terminal, and a third terminal,
the first terminal being electrically connected to the part of the third conductive member,
the second terminal being electrically connected to the other part of the third conductive member,
the third terminal being electrically connected to the other part of the fourth conductive member,
a part of the first switch element being electrically connected to a part of the third switch element and a part of the fifth switch element,
the second terminal being electrically connected to another part of the second switch element and a part of the first switch element,
the third terminal being electrically connected to another part of the third switch element and a part of the fourth switch element, and
another part of the second switch element is electrically connected to another part of the fourth switch element and another part of the sixth switch element.

13. The magnetic component according to claim 2, wherein:
the first conductive portion is wound continuously in a first number of turns around the first core,
the second conductive portion is wound continuously a in a second number of turns around the second core,
the second number of turns is the same as the first number of turns,
the third conductive portion is wound continuously in a third number of turns around the third core,
the fourth conductive portion is wound continuously in a fourth number of turns around the fourth core,
the fourth number of turns is the same as the third number of turns,
the third conductive member is wound continuously in a fifth number of turns around the fifth core,
the fourth conductive member is wound continuously in a sixth number of turns around the sixth core, and
the sixth number of turns is the same as the fifth number of turns.
